(19) United States
(12) Patent Application Publication
(10) Pub. No.: US 2025/0350928 A1
(43) Pub. Date: Nov. 13, 2025

(54) METHOD, DEVICE AND COMPUTER PROGRAM PRODUCT FOR WIRELESS COMMUNICATION

(71) Applicant: ZTE Corporation, Shenzhen (CN)

(72) Inventors: Li NIU, Shenzhen (CN); Bo DAI, Shenzhen (CN); Ting LU, Shenzhen (CN); Yuan GAO, Shenzhen (CN)

(21) Appl. No.: 19/278,474

(22) Filed: Jul. 23, 2025

Related U.S. Application Data
(63) Continuation of application No. PCT/CN2023/091898, filed on Apr. 28, 2023.

(51) Int. Cl. H04W 8/22; H04W 76/20; H04W 92/18

(52) U.S. Cl. CPC H04W 8/22; H04W 76/20; H04W 92/18

(57) ABSTRACT

A wireless communication method is disclosed. The method comprises transmitting, by a relay wireless communication terminal to a wireless communication node, Internet of Things, IoT, information in an IoT wireless communication terminal, wherein the relay wireless communication terminal has a capability of controlling the IoT wireless communication terminal.

### CROSS-REFERENCE TO RELATED APPLICATION(S)

This application is a continuation application of, and claims priority to International Patent Application No. PCT/CN2023/091898, filed Apr. 28, 2023, published as PCT Publication No. WO2024/221475, the disclosure of which is incorporated herein by reference in its entirety.

### TECHNICAL FIELD

This document is directed generally to wireless communications, and in particular to 5^{th} generation (5G) communications or 6^{th} generation (6G) communications.

### BACKGROUND

In recent years, Internet of Things (IoT) based on NB-IoT (Narrowband Internet of Things) and eMTC (enhanced Machine Type Communication) technologies has been widely used or tested in various applications such as smart grid, intelligent parking, intelligent transportation and logistics, smart energy management systems, etc., involving many vertical fields such as smart cities and smart homes. This has rapidly promoted the upgrading and transformation of traditional industries. For example, the smart parking system can meet the deep coverage requirements of underground scenarios, and can achieve various functions such as parking space search, parking lot monitoring, and zone information display based on multiple types of sensors. In the smart grid system, functions such as intelligent meter reading and autonomous fault reporting can be realized. The IoT system based on eMTC technology can realize vehicle tracking, item tracking, and can be applied to transportation and logistics industry, shared bicycle industry, etc.

The large-scale application of IoT technology will give rise to a more diverse market and technological demands, and new IoT applications will continue to emerge. It is foreseeable that a larger number of sensors, IoT devices, or other types of modules will penetrate into various traditional or emerging industries such as agriculture, industry, environmental protection, urban management, and human health. In a smart library, for example, all books may be equipped with electronic tags, and the movement of books throughout the library can be fully tracked, with real-time book searching, positioning, quantity or status statistics, and more. The warehousing and logistics industry may already be a highly automated industry, where administrators can achieve electronic item recording, querying, and tracking through RFID (Radio Frequency Identification) technology-based tags. However, the workload is still enormous, as specialized equipment is needed to read each tag in sequence. People expect more intelligent operations. Due to economic constraints, traditional agriculture may still not be as modernized as expected, but it will become more modernized and intelligent in the future. Various sensors can be used for real-time monitoring of crop growth conditions such as soil, water, light, fertility, pests, and crop growth, and monitoring data can be used to drive small controllers to adjust growth conditions in real-time and handle disasters in a timely manner. Some potential applications may relate to advanced wearable or medical devices, including patches that can be attached to teeth to monitor oral health or diet, and micro-robots that can enter blood vessels for disease treatment, and so on. Overall, these applications will present significantly different requirements from existing IoT applications. For example, the number of such devices will be enormous, the size of many devices will be very small, requiring extremely simple hardware structures, and even the inability to integrate batteries. In addition, even if these devices can integrate batteries, it may be difficult to ensure that a battery can last for a long time due to the wide variety of business models. However, due to the enormous number of these devices, charging or replacing batteries for them will become very difficult, requiring tremendous manpower and material resources, and may even become an impossible task.

### SUMMARY

This document relates to methods, systems, and computer program products for an IoT relay communication.

One aspect of the present disclosure relates to a wireless communication method. In an embodiment, the wireless communication method includes: transmitting, by a relay wireless communication terminal to a wireless communication node, Internet of Things, IoT, information in an IoT wireless communication terminal, wherein the relay wireless communication terminal has a capability of controlling the IoT wireless communication terminal.

Another aspect of the present disclosure relates to a wireless communication method. In an embodiment, the wireless communication method includes: relaying, by a relay wireless communication terminal, Internet of Things, IoT, information between to a wireless communication node and a IoT wireless communication terminal, wherein the relay wireless communication terminal has a capability of controlling the IoT wireless communication terminal.

Another aspect of the present disclosure relates to a wireless communication method. In an embodiment, the wireless communication method includes: receiving, by a wireless communication node from an IoT wireless communication terminal, Internet of Things, IoT, information in the IoT wireless communication terminal via a relay wireless communication terminal, wherein the relay wireless communication terminal has a capability of controlling the IoT wireless communication terminal.

Another aspect of the present disclosure relates to a wireless communication method. In an embodiment, the wireless communication method includes: transmitting, by an Internet of Things, IoT, wireless communication terminal to a wireless communication node, IoT information in the IoT wireless communication terminal via a relay wireless communication terminal, wherein the relay wireless communication terminal has a capability of controlling the IoT wireless communication terminal.

Another aspect of the present disclosure relates to a wireless communication terminal. In an embodiment, the wireless communication terminal includes a communication unit and a processor. The processor is configured to: transmit, via the communication unit to a wireless communication node, Internet of Things, IoT, information in an IoT wireless communication terminal, wherein the relay wireless communication terminal has a capability of controlling the IoT wireless communication terminal.

Another aspect of the present disclosure relates to a wireless communication node. In an embodiment, the wireless communication node includes a communication unit and a processor. The processor is configured to: receive, via the communication unit from an IoT wireless communication terminal, Internet of Things, IoT, information in the IoT wireless communication terminal via a relay wireless communication terminal, wherein the relay wireless communication terminal has a capability of controlling the IoT wireless communication terminal.

Another aspect of the present disclosure relates to a wireless communication terminal. In an embodiment, the wireless communication terminal includes a communication unit and a processor. The processor is configured to: transmit, via the communication unit to a wireless communication node, IoT information in the IoT wireless communication terminal via a relay wireless communication terminal, wherein the relay wireless communication terminal has a capability of controlling the IoT wireless communication terminal.

Various embodiments may preferably implement the following features:
Preferably, the relay wireless communication terminal performs a communication between the relay wireless communication terminal and the IoT wireless communication terminal via an IoT Uu protocol stack of the relay wireless communication terminal,
Preferably, the IoT Uu protocol stack comprises an IoT Uu Layer 1 entity and an IoT Uu Layer 2 entity or comprises an IoT Uu Layer 1 entity, an IoT Uu Layer 2 entity, and an IoT Uu Layer 3 entity.
Preferably, the relay wireless communication terminal performs a communication between the relay wireless communication terminal and the wireless communication node via a Uu protocol stack of the relay wireless communication terminal, and the Uu protocol stack comprises at least one of:
a physical, PHY, entity;
a Medium Access Control, MAC, entity;
a Radio Link Control, RLC, entity;
a Packet Data Convergence Protocol, PDCP, entity;
a Service Data Adaptation Protocol, SDAP, entity; or
a Radio Resource Control, RRC, entity.

Preferably, the relay wireless communication terminal performs a communication between the relay wireless communication terminal and the wireless communication node via a Data Radio Bearer, DRB, or via a Signal Radio Bearer, SRB, with an RRC message.

Preferably, the RRC message comprises at least one of:
an indication indicating that the RRC message is for relaying a data packet from the IoT wireless communication terminal;
an indication indicating that a Protocol Data Unit, PDU, carried by the RRC message is from the IoT wireless communication terminal; or
a PDU from the IoT wireless communication terminal.

Preferably, the relay wireless communication terminal communicates information of the relay wireless communication terminal with the wireless communication node via a first SRB and transmit the IoT information or a data packet from the IoT wireless communication terminal to the wireless communication node, via a second SRB.

Preferably, the relay wireless communication terminal receives a configuration for the second SRB from the wireless communication node, and the configuration for the second SRB comprises at least one of:
an indication indicating that the second SRB is used to transmit the IoT information or a data packet from the IoT wireless communication terminal; or
a logical channel identity indicating the second SRB used to transmit the IoT information or a data packet from the IoT wireless communication terminal.

Preferably, the relay wireless communication terminal transmits the IoT information from the IoT wireless communication terminal to the wireless communication node via a third SRB.

Preferably, the relay wireless communication terminal receives a configuration for the third SRB from the wireless communication node.

Preferably, the configuration for the third SRB comprises at least one of:
an indication indicating that the third SRB is used to transmit the IoT information from the IoT wireless communication terminal; or
a logical channel identity indicating the third SRB used to transmit the IoT information from the IoT wireless communication terminal.

Preferably, the relay wireless communication terminal transmits a data packet from the IoT wireless communication terminal to the wireless communication node via a fourth SRB, and wherein the IoT information is retrieved from the data packet.

Preferably, the relay wireless communication terminal receives a configuration for the fourth SRB from the wireless communication node.

Preferably, the configuration for the fourth SRB comprises at least one of:
an indication indicating that the fourth SRB is used to transmit the data packet from the IoT wireless communication terminal; or
a logical channel identity indicating the fourth SRB used to transmit the data packet from the IoT wireless communication terminal.

Preferably, the relay wireless communication terminal transmits the IoT information to a network node via a PDU session between the relay wireless communication terminal and the network node, wherein the PDU session is dedicated for the IoT information.

Preferably, the relay wireless communication terminal receives a configuration from the wireless communication node for configuring a DRB for the PDU session dedicated for the IoT information.

Preferably, the capability of controlling the IoT wireless communication terminal comprises at least one of:
a capability of determining whether to initiate an inventory procedure for the IoT wireless communication terminal; or
a capability of determining whether to initiate a conflict resolution procedure for a communication between the relay wireless communication terminal and the IoT wireless communication terminal.

Preferably, the wireless communication node communicates with a network node by using a core network, CN, PDU, and the CN PDU comprises at least one of: an identity of the IoT wireless communication terminal, the CN PDU, an indication indicating a type of the IoT wireless communication terminal, or an indication indicating a type of the CN PDU.

Preferably, the wireless communication node communicates with a network node by using a Next Generation, NG, message, and the NG message comprises at least one of: an identity of the IoT wireless communication terminal, a CN PDU in the NG message, an indication indicating a type of the IoT wireless communication terminal, or an indication indicating a type of a CN PDU in the NG message.

Preferably, the wireless communication node performs a communication between the relay wireless communication terminal and the wireless communication node via a Uu protocol stack of the relay wireless communication terminal, and the Uu protocol stack comprises at least one of:
a physical, PHY, entity;
a Medium Access Control, MAC, entity;
a Radio Link Control, RLC, entity;
a Packet Data Convergence Protocol, PDCP, entity;
a Service Data Adaptation Protocol, SDAP, entity; or
a Radio Resource Control, RRC, entity.

Preferably, the wireless communication node performs a communication between the relay wireless communication terminal and the wireless communication node via a Data Radio Bearer, DRB, or via a Signal Radio Bearer, SRB, with an RRC message.

Preferably, the IoT wireless communication terminal performs a communication between the relay wireless communication terminal and the IoT wireless communication terminal via an IoT Uu protocol stack of the relay wireless communication terminal, and wherein the IoT Uu protocol stack comprises an IoT Uu Layer 1 entity and an IoT Uu Layer 2 entity or comprises an IoT Uu Layer 1 entity, an IoT Uu Layer 2 entity, and an IoT Uu Layer 3 entity.

Preferably, the IoT information is transmitted to a network node via a PDU session between the relay wireless communication terminal and the network node, wherein the PDU session is dedicated for the IoT information.

The present disclosure relates to a computer program product comprising a computer-readable program medium code stored thereupon, the code, when executed by a processor, causing the processor to implement a wireless communication method recited in any one of foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

### BRIEF DESCRIPTION OF THE DRAWINGS

The above and other aspects and their implementations are described in greater detail in the drawings, the descriptions, and the claims.

FIG. 1 shows a schematic diagram of an IoT relay communication according to an embodiment of the present disclosure.

FIG. 2 shows a schematic diagram of an IoT relay communication according to an embodiment of the present disclosure.

FIG. 3 shows a schematic diagram of an IoT relay communication according to an embodiment of the present disclosure.

FIG. 4 shows a schematic diagram of an IoT relay communication according to an embodiment of the present disclosure.

FIG. 5 shows a schematic diagram of an IoT relay communication according to an embodiment of the present disclosure.

FIG. 6 shows a schematic diagram of an IoT relay communication according to an embodiment of the present disclosure.

FIG. 7 shows a schematic diagram of an IoT relay communication according to an embodiment of the present disclosure.

FIG. 8 shows a schematic diagram of a procedure according to an embodiment of the present disclosure.

FIG. 9 shows a schematic diagram of a procedure according to an embodiment of the present disclosure.

FIG. 10 shows an example of a schematic diagram of a wireless communication terminal according to an embodiment of the present disclosure.

FIG. 11 shows an example of a schematic diagram of a wireless communication node according to an embodiment of the present disclosure.

FIGS. 12 to 14 show flowcharts of wireless communication methods according to some embodiments of the present disclosure.

### DETAILED DESCRIPTION

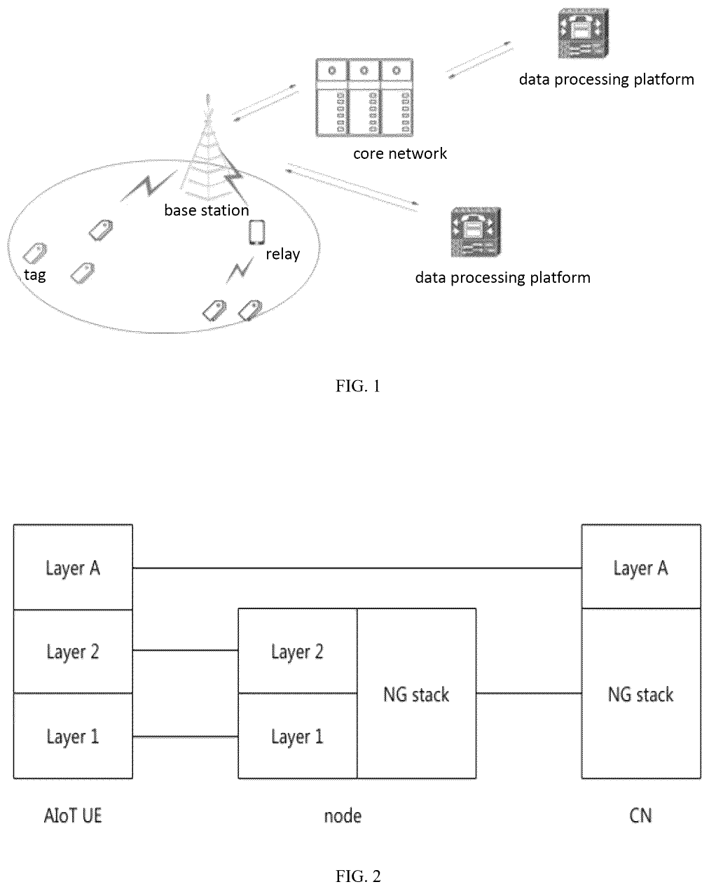

In some embodiments, a large-scale deployment of IoT may be limited by sensor energy consumption, deployment, and maintenance costs. Wireless powered communication network (WPCN), also known as passive IoT, may be a breakthrough for solving such IoT application scenarios. FIG. 1 shows a wireless powered communication network according to an embodiment of the present disclosure.

As illustrated in FIG. 1, the data processing platform is responsible for managing, operating, and maintaining tag data. The core network is responsible for conveying the data from the data processing platform to the base station, or conveying the data from the base station to the data processing platform. The base station may be responsible for the operations on the tags and sending the data from the core network to the tags or sending the tag data to the core network. In scenarios with relays, the relays may be responsible for converting base station commands into commands that tags can recognize and sending them to the tags.

In some embodiments, an IoT UE (user equipment) (e.g., an Ambient Internet of Things (AloT) UE) has the characteristic of a low power consumption, simple protocol stack. The network that supports an access service for this UE also has the characteristic of a simple protocol stack. The architecture of this network may be called a network architecture with a simple stack.

In some embodiments, the IoT Uu interface is between the IoT UE and the node (such as gNB or BS (base station)). In FIG. 2, the Uu Layer 1 entity and the Uu Layer 2 entity are terminated between the IoT UE and the node. The Layer A entity is terminated between the UE and the network function (e.g., a network node) of the core network (such as an AMF (Access and Mobility Management Function)). The NG (next generation) stack(s) are terminated between the node and the network function of the core network (such as AMF). The term entity used in this document indicates an entity or a function performs certain protocol(s) or operation(s), which can be implemented by using a hardware platform and/or a program code.

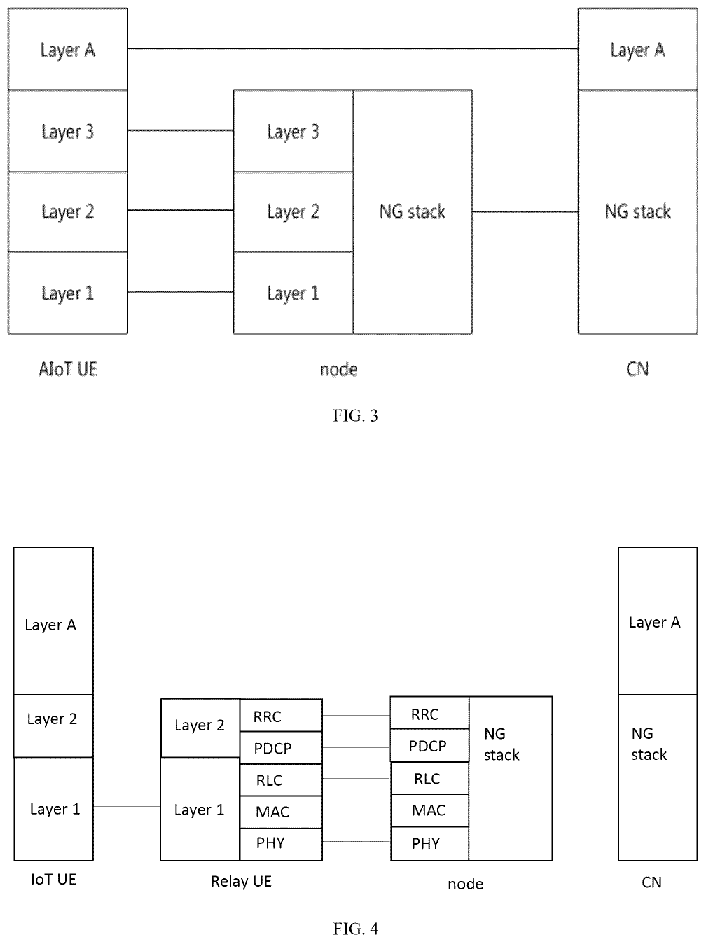

In FIG. 3, the Uu Layer 1 entity, the Uu Layer 2 entity and the Uu Layer 3 entity are terminated between the IoT UE and the node. The Layer A entity is terminated between the IoT UE and the network function of the core network (such as AMF). The NG stack(s) are terminated between the node and the network function of the core network (such as AMF).

In some embodiments, the functions of the Uu Layer 1 entity include at least one of the following: modulation and demodulation, channel coding and decoding, signal generation, physical layer procedures, or physical layer measurement.

In some embodiments, the functions of the Uu Layer 2 entity include at least one of the following: data transfer, conflict resolution, assembling, disassembling, radio resource selection, encryption, decryption, control procedure, or message generation.

In some embodiments, the functions of the Uu Layer 3 entity include at least one of the following: encryption, decryption, or control procedure, message generation.

In some embodiments, the functions of the Layer A entity include at least one of the following: encryption, decryption, control procedure, or message generation.

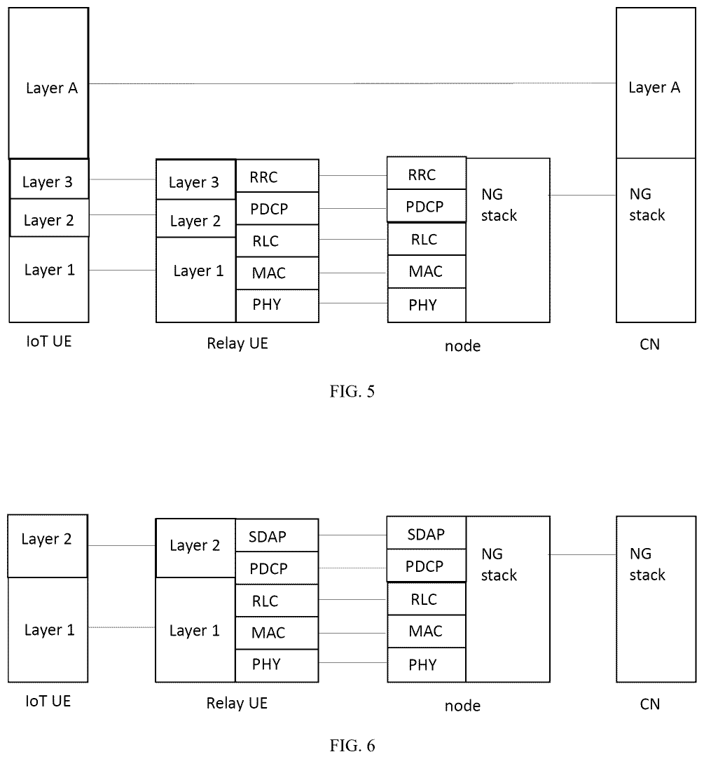

In some embodiments, the power of the IoT UE might be limited, so that the communication distance of the IoT UE is limited. To increase the communication distance, a relay UE (such as an NR UE) may be used to relay the IoT UE's data to the node and/or the core network (see FIGS. 4 and 5).

In some embodiments of the present disclosure, the interface between the IoT UE and the relay UE may be referred to as IoT Uu interface, the interface between the node and the relay UE may be referred to as Uu interface, and the interface between the node and the core network may be referred to as NG interface.

In some embodiments, the functions of the IoT Uu Layer 1 entity (also referred to as IoT Uu Layer 1, IoT Layer 1, or Layer 1) include at least one of the following: modulation and demodulation, channel coding and decoding, signal generation, physical layer procedures, or physical layer measurement.

In some embodiments, the functions of the IoT Uu Layer 2 entity (also referred to as IoT Uu Layer 2, IoT Layer 2, or Layer 2) include at least one of the following: data transfer, conflict resolution, assembling, disassembling, radio resource selection, encryption, decryption, control procedure, or message generation.

In some embodiments, the functions of the IoT Uu Layer 3 entity (also referred to as IoT Uu Layer 3, IoT Layer 3, or Layer 3) include at least one of the following: encryption, decryption, or control procedure, message generation.

In some embodiments, the data that is transmitted between the IoT UE and the core network may be referred to as the CN (core network) PDU (Protocol Data Unit).

In some embodiments, the data that is transmitted between the IoT Layer 1 entity and the IoT Layer 2 entity in the relay UE or IoT UE may be referred to as the Layer 2 PDU.

In some embodiments, the data that is transmitted between the IoT Layer 2 and Layer 3 entities in the relay UE or IoT UE may be referred to as the Layer 3 PDU.

In the paragraphs below, details will be described along with many aspects, but the present disclosure is not limited to the paragraphs below.

### Aspect 1 (Architecture 1):

FIGS. 4 and 5 show examples of the relay architecture according to some embodiments of the present disclosure.

In some embodiments, the relay UE may have the capability of controlling the IoT UE (e.g., controlling the procedure (such as conflict resolution) in (or associated with) the IoT UE), and disassembling or assembling the Layer 2 PDU and Layer 3 PDU (optional) (see FIG. 5). In some embodiments, the capability of controlling the IoT UE includes at least one of: a capability of determining whether to initiate an inventory procedure for the IoT UE; or a capability of determining whether to initiate a conflict resolution procedure for the communication between the relay UE and the IoT UE.

In some embodiments, if the Layer 2 PDU or the Layer 3 PDU for the IoT UE carry some information, such as the control information about conflict resolution, the relay UE may disassemble the Layer 2 PDU or the Layer 3 PDU to obtain the information, and control the IoT UE accordingly. The relay UE may also generate certain messages (e.g., for control the IoT UE) and assemble the message as a Layer 2 or Layer 3 PDU to be transmitted to the IoT UE. That is, relay UE may have the function of the Layer 2 or the Layer 3.

In some embodiments, the IoT Uu stack (e.g., including the IoT Uu Layer 1 and Layer 2) are terminated between the IoT UE and the relay UE (see FIG. 4).

In some embodiments, the IoT Uu stack (e.g., including the IoT Uu Layer 1, Layer 2 and Layer 3) are terminated between the IoT UE and the relay UE (see FIG. 5).

In some embodiments, the Uu stack (e.g., including PDCP (Packet Data Convergence Protocol) protocol entity (also referred to as PDCP), RLC (Radio Link Control) protocol entity (also referred to as RLC), MAC (Medium Access Control) protocol entity (also referred to as MAC), and PHY (Physical) protocol entity (also referred to as PHY)) is terminated between the node and the relay UE.

In some embodiments, the IoT Uu Layer 1, Layer 2 and Layer 3 (optional) of the IoT UE are used to assemble the PDU(s) to be transmitted to the relay UE, the node, and/or the CN. In some embodiments, the IoT Uu Layer 1, Layer 2 and Layer 3 (optional) of the IoT UE are used to parse the PDU(s) received from the relay UE, the node, and/or the CN.

In some embodiments, for the relay UE, it may parse the PDU(s) from the IoT UE by the IoT Uu Layer 1, Layer 2 and Layer 3 (optional) of the relay UE and obtain the information in the PDU(s). If the relay UE obtains some information or a data packet need to be sent to the node or the core network, the relay UE may generate an RRC (Radio Resource Control) message carrying the information or the data packet. The RRC message could be the ULInformationTransfer, UE information or another message. The relay UE may process this RRC message through the PDCP (Packet Data Convergence Protocol) protocol entity (also referred to as PDCP), RLC (Radio Link Control) protocol entity (also referred to as RLC), MAC (Medium Access Control) protocol entity (also referred to as MAC), and PHY (Physical) protocol entity (also referred to as PHY), and transmit the RRC message to the node.

In some embodiments, the RRC message could carry some information including one or more of the following:
the indication that indicates this RRC message is for relaying the data packet from the IoT UE;
the indication that indicates the carried PDU is from the IoT UE; and/or
the PDU, such as the CN PDU.

In some embodiments, the node may receive an RRC message from the relay UE by the PDCP protocol entity, RLC protocol entity, MAC protocol entity, and PHY protocol entity of the relay UE. In some embodiments, the node may also transmit an RRC message to the relay UE by the PDCP protocol entity, RLC protocol entity, MAC protocol entity, and PHY protocol entity of the relay UE.

### Aspect 2 (Architecture 2):

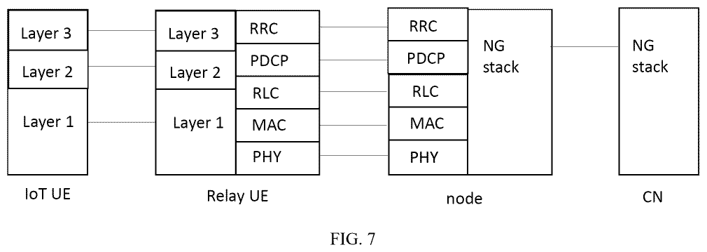

FIGS. 6 and 7 show examples of the relay architecture according to some embodiments of the present disclosure.

In some embodiments, the relay UE may have the capability of controlling the IoT UE (e.g., controlling the procedure (such as conflict resolution) in (or associated with) the IoT UE), and disassembling or assembling the Layer 2 PDU and Layer 3 PDU (optional) (see FIG. 7). In some embodiments, the capability of controlling the IoT UE includes at least one of: a capability of determining whether to initiate an inventory procedure for the IoT UE; or a capability of determining whether to initiate a conflict resolution procedure for the communication between the relay UE and the IoT UE.

In some embodiments, if the Layer 2 PDU or the Layer 3 PDU for the IoT UE carry some information, such as the control information about conflict resolution, the relay UE may disassemble the Layer 2 PDU or the Layer 3 PDU to obtain the information, and control the IoT UE accordingly. The relay UE may also generate certain messages (e.g., for control the IoT UE) and assemble the message as a Layer 2 or Layer 3 PDU to be transmitted to the IoT UE. That is, relay UE may have the function of the Layer 2 or the Layer 3.

In some embodiments, the IoT Uu stack (e.g., including the IoT Uu Layer 1 and Layer 2) are terminated between the IoT UE and the relay UE (see FIG. 6).

In some embodiments, the IoT Uu stack (e.g., including the IoT Uu Layer 1, Layer 2 and Layer 3) are terminated between the IoT UE and the relay UE (see FIG. 7).

In some embodiments, the Uu stack (e.g., including SDAP (Service Data Adaptation Protocol) protocol entity (also referred to as SDAP), RLC (Radio Link Control) protocol entity (also referred to as RLC), MAC (Medium Access Control) protocol entity (also referred to as MAC), and PHY (Physical) protocol entity (also referred to as PHY) is terminated between the node and the relay UE.

In some embodiments, the IoT Uu Layer 1, Layer 2 and Layer 3 (optional) of the IoT UE are used to assemble the PDU(s) to be transmitted to the relay UE, the node, and/or the CN. In some embodiments, the IoT Uu Layer 1, Layer 2 and Layer 3 (optional) of the IoT UE are used to parse the PDU(s) received from the relay UE, the node, and/or the CN.

In some embodiments, the IoT Uu Layer 1, Layer 2 and Layer 3 (optional) of the IoT UE are used to assemble the PDU(s) to be transmitted to the relay UE, the node, and/or the CN. In some embodiments, the IoT Uu Layer 1, Layer 2 and Layer 3 (optional) of the IoT UE are used to parse the PDU(s) received from the relay UE, the node, and/or the CN.

In some embodiments, for the relay UE, it may parse the PDU(s) from the IoT UE and obtain the information in the PDU by the IoT Uu Layer 1, Layer 2 and Layer 3 (optional) of the relay UE. If the relay UE obtains some information or a data packet need to be sent to the node or the core network, the relay UE may deliver it to the node via a DRB (Data Radio Bearer). The node may deliver it to the CN via a PDU session or QoS (quality of service) flow. In some embodiments, the relay UE may also receive some information or a data packet via the DRB. The node may receive it from the CN via a PDU session or QoS flow.

In some embodiments, the relay UE may process the information or the data packet need to be sent to the node and/or the core network through the SDAP (Service Data Adaptation Protocol) protocol entity (also referred to as SDAP), RLC (Radio Link Control) protocol entity (also referred to as RLC), MAC (Medium Access Control) protocol entity (also referred to as MAC), and PHY (Physical) protocol entity (also referred to as PHY), and transmit the information or the data packet to the node and/or CN.

In some embodiments, the relay UE may receive PDU(s) from the node and/or the core network through the SDAP protocol entity, RLC protocol entity, MAC protocol entity, and PHY protocol entity of the relay UE.

### Aspect 3 (New SRB):

In some embodiments, the relay UE may send the RRC message carrying the information of the relay UE and the RRC message carrying the information or data packet from the IoT UE to the node. In order to distinguish them, the node could configure two different SRBs for the relay UE. The first SRB is used to transmit the RRC message carrying the information of the relay UE, and the second SRB is used to transmit the RRC message carrying the information or data packet from the IoT UE. The node could send the configuration of the second SRB, including at least one of:
an indication that indicates the second SRB is used to transmit the RRC message carrying the information or data packet from the IoT UE; and/or
a logical channel identity that indicates the SRB used to transmit the RRC message carrying the information or data packet from the IoT UE.

In some embodiments, the relay UE may send the RRC message carrying the information or data packet from the IoT UE to the node, in which the information is extracted from the data packet. To distinguish them, the node could configure different SRBs for the relay UE. For example, the first SRB may be configured to be used to transmit the RRC message carrying the information from the IoT UE, and the second SRB may be configured to be used to transmit the RRC message carrying the data packet from the IoT UE.

In some embodiments, the node could transmit the configuration of the first SRB to the relay UE, including at least one of:
an indication that indicates the first SRB is used to transmit the RRC message carrying the information from the IoT UE; and/or
a first logical channel identity that indicates the first SRB used to transmit the RRC message carrying the information from the IoT UE.

In some embodiments, the node could transmit the configuration of the second SRB to the relay UE, including at least one of:
an indication that indicates the second SRB is used to transmit the RRC message carrying data packet from the IoT UE; and/or
a second logical channel identity that indicates the second SRB used to transmit the RRC message carrying the data packet from the IoT UE.

### Aspect 4 (Procedure 1):

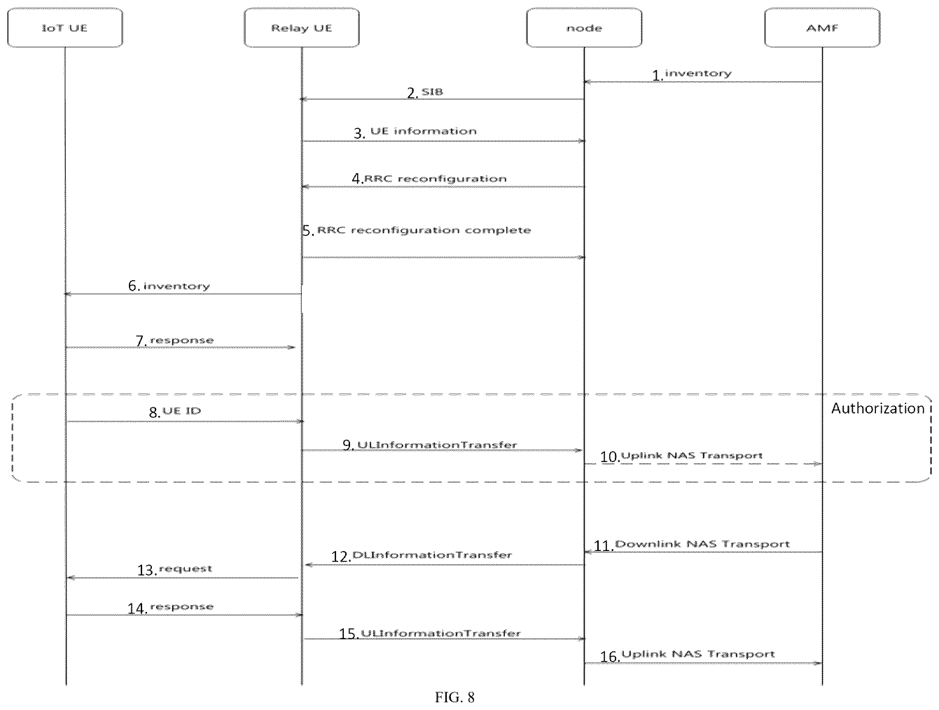

FIG. 8 shows an example a procedure according to some embodiments of the present disclosure.

In some embodiment, the procedure may include the steps described below.
1. The CN may trigger an inventory procedure and send an NG message carrying inventory information to the node.
2. The node may broadcast a system information about the IoT communication, including the IoT relay communication, for example, the node supports the IoT relay communication, and may allocate some resources for it.
3. The relay UE may send an RRC message, such as UE information, to the node, to request an IoT relay communication.
4. The node may send an RRC message, such as the RRC reconfiguration, to the relay UE to enable the IoT relay communication and allocate the dedicated resource for it.
5. The relay UE may respond the RRC message with an RRC complete message.
6. The relay UE may trigger an inventory procedure for the IoT UE.
7. The IoT UE may send a response for the inventory procedure to the relay UE.
(In step 6 and step 7, some steps or messages may be omitted during the inventory procedure.)
8. The IoT UE may send a PDU carrying its identity to the relay UE and/or send an encrypted result according to the authentication algorithm as a CN PDU to the relay UE.
9. The relay UE may generate an RRC message carrying the CN PDU and send it to the node.
10. The node may send an NG message carrying the CN PDU to the CN.
(In step 8 and step 10, some steps or messages may be omitted during the inventory procedure.)
11. The CN may send an NG message carrying the CN PDU for the IoT UE to the node.
12. The node may send an RRC message carrying the CN PDU to the relay UE.
13. The relay UE may send a message carrying the CN PDU to the IoT UE. For example, the message may be a read request message.
14. The IoT UE may respond the message from the relay UE and send a message carrying a CN PDU to the relay UE. For example, the message may be a read response message.
15. The relay UE may generate an RRC message carrying the CN PDU and send it to the node.
16. The node may send an NG message carrying the CN PDU to the CN.

### Aspect 5 (Procedure 2):

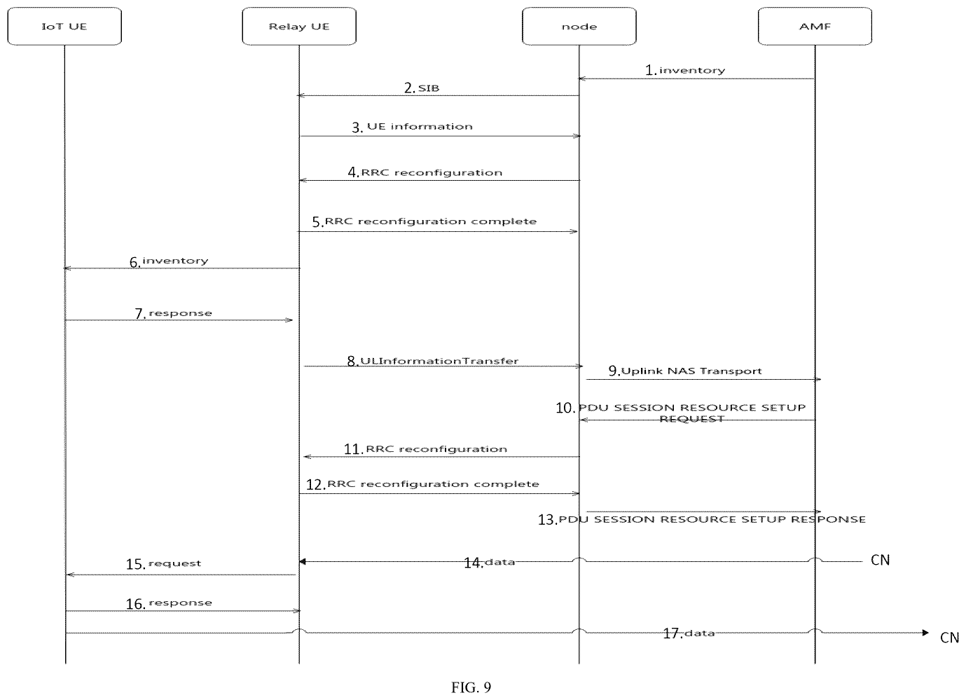

FIG. 9 shows an example a procedure according to some embodiments of the present disclosure.

In some embodiment, the procedure may include the steps described below.
1. The CN may trigger an inventory procedure and send an NG message carrying inventory information to the node.
2. The node may broadcast a system information about the IoT communication, including the IoT relay communication, for example, the node supports the IoT relay communication, and may allocate some resources for it.
3. The relay UE may send an RRC message, such as UE information, to the node, to request an IoT relay communication.
4. The node may send an RRC message, such as the RRC reconfiguration, to the relay UE to enable the IoT relay communication and allocate the dedicated resource for it.
5. The relay UE may respond the RRC message with an RRC complete message.
6. The relay UE may trigger an inventory procedure for the IoT UE.
7. The IoT UE may send a response for the inventory procedure to the relay UE.
(In step 6 and step 7, some steps or messages may be omitted during the inventory procedure.)
8. The relay UE may trigger a service request procedure, generate an RRC message carrying the NAS (Non-access stratum) PDU, and send the RRC message to the node.
9. The node may send an NG message carrying the NAS PDU to the CN.
10. The CN may trigger a PDU session establishment or modification procedure, and send a PDU session setup or a PDU session modification request message to the node, in which this PDU session is for the IoT relay communication.
11. The node may send an RRC reconfiguration to the relay UE to establish a corresponding DRB and allocate the dedicated resource for the DRB.
12. The relay UE may response an RRC complete message to the node.
13. The relay UE may response a PDU session setup complete message or a PDU session modification complete message to the CN.
14. The data packet from the CN could be send to the relay UE via the PDU session and the corresponding DRB.
15. The relay may send a message carrying a CN PDU to the IoT UE. For example, the message may be a read request message.
16. The node may send a response message carrying the CN PDU to the relay UE. For example, the message may be a read response message.
17. The data packet from the IoT UE could be send to the CN via the PDU session and the corresponding DRB.
   Aspect 6 (NG interface):

In some embodiment, the node may not be able to discriminate the PDU carried in the RRC message, and distinguish whether the PDU is from or to the IoT UE. In some embodiment, the node may not be able to establish a connection in the NG interface with the CN for the IoT UE. In some embodiment, the node may not be able to know the relationship between the relay UE and the IoT UE. In some embodiment, the relay UE and the CN may be responsible to distinguish whether the PDU is from or to the IoT UE.

Option 1:
In some embodiment, the CN PDU could carry some information about the IoT UE. The information could include at least one of: the identity of the IoT UE, the CN PDU, an indication indicating the type of the IoT UE, or an indication indicating the type of the CN PDU.

### Option 2:

In some embodiment, the NG message could carry some information about the IoT UE. The UL (uplink) NG message could be an INITIAL UE MESSAGE, an UPLINK NAS TRANSPORTor another message, and the UL NG message could carry at least one of: the identity of the IoT UE, the CN PDU, an indication indicating the type of the IoT UE, or an indication indicating the type of the CN PDU. The DL (downlink) NG message could be a Downlink NAS TRANSPORT or another message, and the DL NG message could carry at least one of: the identity of the IoT UE, the CN PDU, an indication indicating the type of the IoT UE, or an indication indicating the type of the CN PDU.

### Option 3:

In some embodiment, a (dedicated) PDU session is established for the IoT UE. the node and the CN could transfer the data packet of the IoT UE in this PDU session. The CN may send a DL message to the node to trigger a PDU session establishment, and the node may establish the corresponding DRB. The DL message could be a PDU SESSION RESOURCE SETUP REQUEST or another message, and the message could carry at least one of: the identity of the IoT UE or an indication indicating the type of the IoT UE.

In the paragraphs below, details will be described along with some examples, but the present disclosure is not limited to the example below.

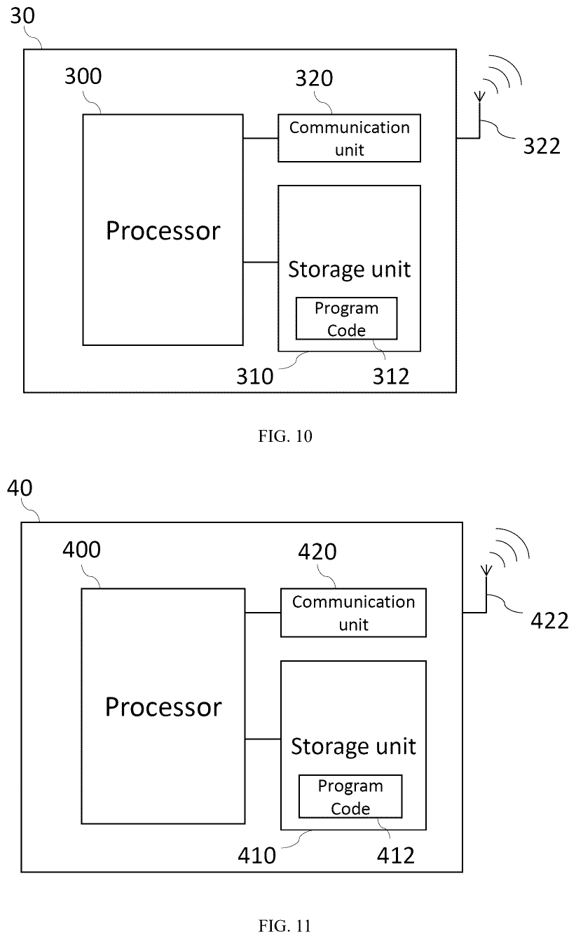

FIG. 10 relates to a diagram of a wireless communication terminal 30 according to an embodiment of the present disclosure. The wireless communication terminal 30 may be a tag, a mobile phone, a laptop, a tablet computer, an electronic book or a portable computer system and is not limited herein. The wireless communication terminal 30 may be used to implement the relay UE or the IoT UE described in this disclosure. The wireless communication terminal 30 may include a processor 300 such as a microprocessor or Application Specific Integrated Circuit (ASIC), a storage unit 310 and a communication unit 320. The storage unit 310 may be any data storage device that stores a program code 312, which is accessed and executed by the processor 300. Embodiments of the storage code 312 include but are not limited to a subscriber identity module (SIM), read-only memory (ROM), flash memory, random-access memory (RAM), hard-disk, and optical data storage device. The communication unit 320 may a transceiver and is used to transmit and receive signals (e.g., messages or packets) according to processing results of the processor 300. In an embodiment, the communication unit 320 transmits and receives the signals via at least one antenna 322.

In an embodiment, the storage unit 310 and the program code 312 may be omitted and the processor 300 may include a storage unit with stored program code.

The processor 300 may implement any one of the steps in exemplified embodiments on the wireless communication terminal 30, e.g., by executing the program code 312.

The communication unit 320 may be a transceiver. The communication unit 320 may as an alternative or in addition be combining a transmitting unit and a receiving unit configured to transmit and to receive, respectively, signals to and from a wireless communication node or another wireless communication terminal 30.

In some embodiments, the wireless communication terminal 30 may be used to perform the operations of the relay UE or the IoT UE described above. In some embodiments, the processor 300 and the communication unit 320 collaboratively perform the operations described above. For example, the processor 300 performs operations and transmit or receive signals, message, and/or information through the communication unit 320.

FIG. 11 relates to a diagram of a wireless communication node 40 according to an embodiment of the present disclosure. The wireless communication node 40 may be a satellite, a base station (BS), a gNB, a network entity, a Domain Name System (DNS) server, a Mobility Management Entity (MME), Serving Gateway (S-GW), Packet Data Network (PDN) Gateway (P-GW), a radio access network (RAN), a next generation RAN (NG-RAN), a data network, a core network, a communication node in the core network, or a Radio Network Controller (RNC), and is not limited herein. In addition, the wireless communication node 40 may include (perform) at least one network function such as an access and mobility management function (AMF), a session management function (SMF), a user place function (UPF), a policy control function (PCF), an application function (AF), etc. The wireless communication node 40 may be used to implement the node, the core network, the network functions (e.g., the AMF, the PCF, etc.), or a network node in the core network described in this disclosure. The wireless communication node 40 may include a processor 400 such as a microprocessor or ASIC, a storage unit 410 and a communication unit 420. The storage unit 410 may be any data storage device that stores a program code 412, which is accessed and executed by the processor 400. Examples of the storage unit 412 include but are not limited to a SIM, ROM, flash memory, RAM, hard-disk, and optical data storage device. The communication unit 420 may be a transceiver and is used to transmit and receive signals (e.g., messages or packets) according to processing results of the processor 400. In an example, the communication unit 420 transmits and receives the signals via at least one antenna 422.

In an embodiment, the storage unit 410 and the program code 412 may be omitted. The processor 400 may include a storage unit with stored program code.

The processor 400 may implement any steps described in exemplified embodiments on the wireless communication node 40, e.g., via executing the program code 412.

The communication unit 420 may be a transceiver. The communication unit 420 may as an alternative or in addition be combining a transmitting unit and a receiving unit configured to transmit and to receive, respectively, signals, messages, or information to and from another wireless communication node or a wireless communication terminal.

In some embodiments, the wireless communication node 40 may be used to perform the operations of the node, the core network, the network functions (e.g., the AMF, the PCF, etc.), or a network node in the core network described in this disclosure. In some embodiments, the processor 400 and the communication unit 420 collaboratively perform the operations described above. For example, the processor 400 performs operations and transmit or receive signals through the communication unit 420.

A wireless communication method is also provided according to an embodiment of the present disclosure. In an embodiment, the wireless communication method may be performed by using a wireless communication terminal (e.g., a relay UE). In an embodiment, the wireless communication terminal may be implemented by using the wireless communication terminal 40 described above, but is not limited thereto.

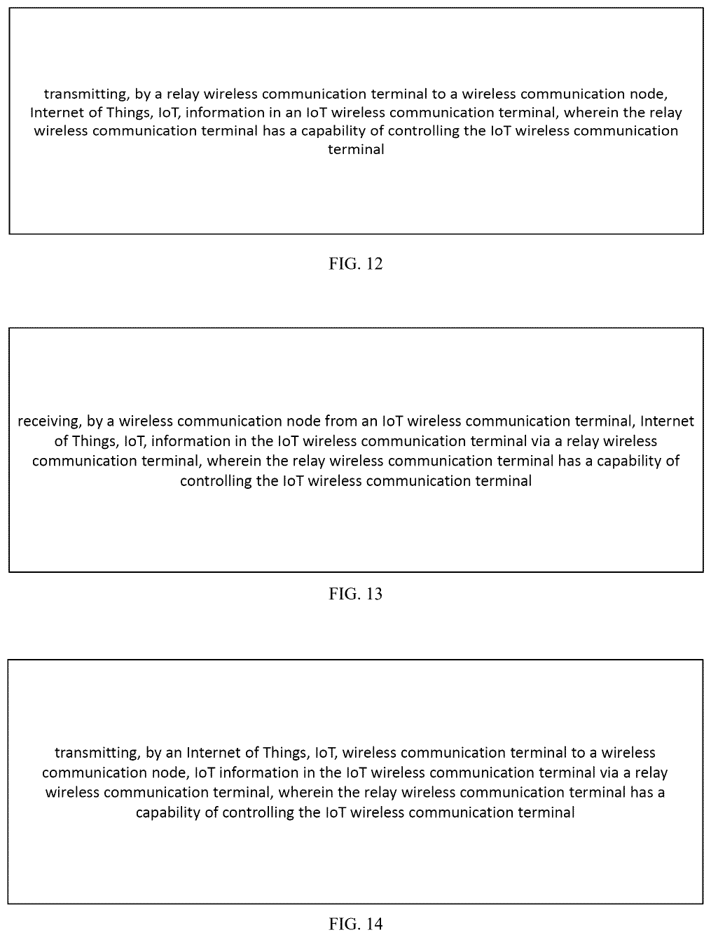

Referring to FIG. 12, in an embodiment, the wireless communication method includes: transmitting, by a relay wireless communication terminal to a wireless communication node, Internet of Things, IoT, information in an IoT wireless communication terminal, wherein the relay wireless communication terminal has a capability of controlling the IoT wireless communication terminal.

Details in this regard can be ascertained with reference to the paragraphs above, and will not be repeated herein.

Another wireless communication method is also provided according to an embodiment of the present disclosure. In an embodiment, the wireless communication method may be performed by using a wireless communication node (e.g., a node). In an embodiment, the wireless communication node may be implemented by using the wireless communication node 50 described above, but is not limited thereto.

Referring to FIG. 13, in an embodiment, the wireless communication method includes receiving, by a wireless communication node from an IoT wireless communication terminal, Internet of Things, IoT, information in the IoT wireless communication terminal via a relay wireless communication terminal, wherein the relay wireless communication terminal has a capability of controlling the IoT wireless communication terminal.

Details in this regard can be ascertained with reference to the paragraphs above, and will not be repeated herein.

Another wireless communication method is also provided according to an embodiment of the present disclosure. In an embodiment, the wireless communication method may be performed by using a wireless communication terminal (e.g., an IoT UE). In an embodiment, the wireless communication terminal may be implemented by using the wireless communication terminal 40 described above, but is not limited thereto.

Referring to FIG. 14, in an embodiment, the wireless communication method includes: transmitting, by an Internet of Things, IoT, wireless communication terminal to a wireless communication node, IoT information in the IoT wireless communication terminal via a relay wireless communication terminal, wherein the relay wireless communication terminal has a capability of controlling the IoT wireless communication terminal.

Details in this regard can be ascertained with reference to the paragraphs above, and will not be repeated herein.

In some embodiments, the IoT information used in the present disclosure may include at least one of: information of the IoT wireless communication terminal, information of the wireless communication node, information for the connection between the wireless communication node and the IoT wireless communication terminal, a configuration for the IoT wireless communication terminal, the data collected by the IoT wireless communication terminal, or an instruction for reading the data collected by the IoT wireless communication terminal.

In some embodiments, the IoT wireless communication terminal used in the present disclosure may indicate the IoT UE described above.

In some embodiments, the relay wireless communication terminal used in the present disclosure may indicate the relay UE described above.

In some embodiments, the wireless communication node used in the present disclosure may indicate the node, BS, or gNB described above.

In some embodiments, the configuration information used in the present disclosure may indicate the common configuration and/or the dedicated configuration described above.

In some embodiments, the relay function used in the present disclosure may indicate the relay wireless communication terminal relaying the IoT information for the communication between the wireless communication node and the IoT wireless communication terminal.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general-purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general-purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

I/We claim:

1. A wireless communication method comprising:
transmitting, by a relay wireless communication terminal to a wireless communication node, Internet of Things, IoT, information in an IoT wireless communication terminal, wherein the relay wireless communication terminal has a capability of controlling the IoT wireless communication terminal.

2. The wireless communication method of claim 1, wherein the relay wireless communication terminal performs a communication between the relay wireless communication terminal and the IoT wireless communication terminal via an IoT Uu protocol stack of the relay wireless communication terminal,
and wherein the IoT Uu protocol stack comprises an IoT Uu Layer 1 entity and an IoT Uu Layer 2 entity or comprises an IoT Uu Layer 1 entity, an IoT Uu Layer 2 entity, and an IoT Uu Layer 3 entity.

3. The wireless communication method of claim 1, wherein the relay wireless communication terminal performs a communication between the relay wireless communication terminal and the wireless communication node via a Data Radio Bearer, DRB, or via a Signal Radio Bearer, SRB, with an RRC message; and
wherein the RRC message comprises at least one of:
an indication indicating that the RRC message is for relaying a data packet from the IoT wireless communication terminal;
an indication indicating that a Protocol Data Unit, PDU, carried by the RRC message is from the IoT wireless communication terminal; or
a PDU from the IoT wireless communication terminal.

4. The wireless communication method of claim 1, wherein the relay wireless communication terminal communicates information of the relay wireless communication terminal with the wireless communication node via a first SRB and transmit the IoT information or a data packet from the IoT wireless communication terminal to the wireless communication node, via a second SRB; and
wherein the relay wireless communication terminal receives a configuration for the second SRB from the wireless communication node, and the configuration for the second SRB comprises at least one of:
an indication indicating that the second SRB is used to transmit the IoT information or a data packet from the IoT wireless communication terminal; or
a logical channel identity indicating the second SRB used to transmit the IoT information or a data packet from the IoT wireless communication terminal.

5. The wireless communication method of claim 1, wherein the relay wireless communication terminal transmits the IoT information from the IoT wireless communication terminal to the wireless communication node via a third SRB; and
wherein the relay wireless communication terminal receives a configuration for the third SRB from the wireless communication node, and the configuration for the third SRB comprises at least one of:
an indication indicating that the third SRB is used to transmit the IoT information from the IoT wireless communication terminal; or
a logical channel identity indicating the third SRB used to transmit the IoT information from the IoT wireless communication terminal.

6. The wireless communication method of claim 1, wherein the relay wireless communication terminal transmits a data packet from the IoT wireless communication terminal to the wireless communication node via a fourth SRB, and wherein the IoT information is retrieved from the data packet; and
wherein the relay wireless communication terminal receives a configuration for the fourth SRB from the wireless communication node, and the configuration for the fourth SRB comprises at least one of:
an indication indicating that the fourth SRB is used to transmit the data packet from the IoT wireless communication terminal; or
a logical channel identity indicating the fourth SRB used to transmit the data packet from the IoT wireless communication terminal.

7. The wireless communication method of claim 1, wherein the relay wireless communication terminal transmits the IoT information to a network node via a PDU session between the relay wireless communication terminal and the network node, wherein the PDU session is dedicated for the IoT information; and
wherein the relay wireless communication terminal receives a configuration from the wireless communication node for configuring a DRB for the PDU session dedicated for the IoT information.

8. The wireless communication method of claim 1, wherein the capability of controlling the IoT wireless communication terminal comprises at least one of:
a capability of determining whether to initiate an inventory procedure for the IoT wireless communication terminal; or
a capability of determining whether to initiate a conflict resolution procedure for a communication between the relay wireless communication terminal and the IoT wireless communication terminal.

9. A wireless communication method comprising:
receiving, by a wireless communication node from an IoT wireless communication terminal, Internet of Things, IoT, information in the IoT wireless communication terminal via a relay wireless communication terminal, wherein the relay wireless communication terminal has a capability of controlling the IoT wireless communication terminal.

10. The wireless communication method of claim 9, wherein the wireless communication node communicates with a network node by using a core network, CN, PDU, and the CN PDU comprises at least one of: an identity of the IoT wireless communication terminal, the CN PDU, an indication indicating a type of the IoT wireless communication terminal, or an indication indicating a type of the CN PDU.

11. The wireless communication method of claim 9, wherein the wireless communication node communicates with a network node by using a Next Generation, NG, message, and the NG message comprises at least one of: an identity of the IoT wireless communication terminal, a CN PDU in the NG message, an indication indicating a type of the IoT wireless communication terminal, or an indication indicating a type of a CN PDU in the NG message.

12. The wireless communication method of claim 9, wherein the wireless communication node performs a communication between the relay wireless communication terminal and the wireless communication node via a Data Radio Bearer, DRB, or via a Signal Radio Bearer, SRB, with an RRC message; and
wherein the RRC message comprises at least one of:
an indication indicating that the RRC message is for relaying a data packet from the IoT wireless communication terminal;
an indication indicating that a Protocol Data Unit, PDU, carried by the RRC message is from the IoT wireless communication terminal; or
a PDU from the IoT wireless communication terminal.

13. The wireless communication method of claim 9, wherein the relay wireless communication terminal communicates information of the relay wireless communication terminal with the wireless communication node via a first SRB and transmit the IoT information or a data packet from the IoT wireless communication terminal with the wireless communication node, via a second SRB; and
wherein the relay wireless communication terminal receives a configuration for the second SRB from the wireless communication node, and the configuration for the second SRB comprises at least one of:
an indication indicating that the second SRB is used to transmit the IoT information or a data packet from the IoT wireless communication terminal; or
a logical channel identity indicating the second SRB used to transmit the IoT information or a data packet from the IoT wireless communication terminal.

14. The wireless communication method of claim 9, wherein the relay wireless communication terminal transmits the IoT information from the IoT wireless communication terminal to the wireless communication node via a third SRB; and
wherein the relay wireless communication terminal receives a configuration for the third SRB from the wireless communication node, and the configuration for the third SRB comprises at least one of:
an indication indicating that the third SRB is used to transmit the IoT information from the IoT wireless communication terminal; or
a logical channel identity indicating the third SRB used to transmit the IoT information from the IoT wireless communication terminal.

15. The wireless communication method of claim 9, wherein the relay wireless communication terminal transmits a data packet from the IoT wireless communication terminal to the wireless communication node via a fourth SRB, and wherein the IoT information is retrieved from the data packet; and
wherein the relay wireless communication terminal receives a configuration for the fourth SRB from the wireless communication node, and the configuration for the fourth SRB comprises at least one of:
an indication indicating that the fourth SRB is used to transmit the data packet from the IoT wireless communication terminal; or
a logical channel identity indicating the fourth SRB used to transmit the data packet from the IoT wireless communication terminal.

16. The wireless communication method of claim 9, wherein the capability of controlling the IoT wireless communication terminal comprises at least one of:
a capability of determining whether to initiate an inventory procedure for the IoT wireless communication terminal; or
a capability of determining whether to initiate a conflict resolution procedure for a communication between the relay wireless communication terminal and the IoT wireless communication terminal.

17. A wireless communication method comprising:
transmitting, by an Internet of Things, IoT, wireless communication terminal to a wireless communication node, IoT information in the IoT wireless communication terminal via a relay wireless communication terminal, wherein the relay wireless communication terminal has a capability of controlling the IoT wireless communication terminal.

18. The wireless communication method of claim 17, wherein the IoT wireless communication terminal performs a communication between the relay wireless communication terminal and the IoT wireless communication terminal via an IoT Uu protocol stack of the relay wireless communication terminal,
and wherein the IoT Uu protocol stack comprises an IoT Uu Layer 1 entity and an IoT Uu Layer 2 entity or comprises an IoT Uu Layer 1 entity, an IoT Uu Layer 2 entity, and an IoT Uu Layer 3 entity.

19. The wireless communication method of claim 17, wherein the IoT information is transmitted to a network node via a PDU session between the relay wireless communication terminal and the network node, wherein the PDU session is dedicated for the IoT information.

20. The wireless communication method of claim 17, wherein the capability of controlling the IoT wireless communication terminal comprises at least one of:
a capability of determining whether to initiate an inventory procedure for the IoT wireless communication terminal; or
a capability of determining whether to initiate a conflict resolution procedure for a communication between the relay wireless communication terminal and the IoT wireless communication terminal.
